(19) United States
(12) Patent Application Publication
(10) Pub. No.: US 2025/0307372 A1
(43) Pub. Date: Oct. 2, 2025

(54) ARTIFICIAL INTELLIGENCE MODEL MANAGEMENT AND CONTROL

(71) Applicant: Express Scripts Strategic Development, Inc., St. Louis, MO (US)

(72) Inventors: Jason Bayldon, Tampa, FL (US); Chakravarthy B. Metturdharma, Avon, CT (US)

(21) Appl. No.: 19/092,384

(22) Filed: Mar. 27, 2025

Related U.S. Application Data
(60) Provisional application No. 63/570,596, filed on Mar. 27, 2024.

(51) Int. Cl. G06F 21/33; G06F 21/62

(52) U.S. Cl. CPC G06F 21/33; G06F 21/6245

(57) ABSTRACT

A method for managing artificial intelligence (AI) systems includes receiving an identity token associated with a first user. The method includes determining whether the identity token is authorized. The method includes, in response to a determination that the identity token is not authorized, transforming a user interface to display a first error prompt. The method includes, in response to a determination that the identity token is authorized, reviewing a first prompt by determining whether the first prompt has met a set of criteria. The method includes, in response to the first prompt meeting the set of criteria, using the first prompt as input to the AI systems. The method includes receiving a first response associated with the first prompt from the AI systems and, in response to a determination that the first response has met a second set of criteria, transforming the user interface to display the first response.

### CROSS-REFERENCE TO RELATED APPLICATIONS

This application claims the benefit of U.S. Provisional Application No. 63/570,596 (Attorney Docket No. ESRX-468PRV) filed Mar. 27, 2024.

### FIELD

The present disclosure relates to large language models and generative artificial intelligence systems, and in particular, to managing and controlling access to artificial intelligence systems.

### BACKGROUND

Large language models (LLMs) and other artificial intelligence (AI) systems can save time and costs in a variety of scenarios. Changes to AI systems come frequently with the introduction of new versions, features, or entirely new systems. Which models to use, maintaining privacy, maintaining confidentiality of information, controlling access, and verifying responses from AI models is of paramount importance.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method for managing a set of artificial intelligence (AI) systems includes receiving an identity token associated with a first user. The method includes determining whether the identity token associated with the first user is authorized. The method includes, in response to a determination that the identity token associated with the first user is not authorized, transforming a user interface to display a first error prompt. The method includes, in response to a determination that the identity token associated with the first user is authorized, reviewing a first prompt by determining whether the first prompt has met a set of criteria. The method includes, in response to a determination that the first prompt has met the set of criteria, using the first prompt as input to the set of AI systems. The method includes receiving a first response associated with the first prompt from the set of AI systems. The method includes, in response to a determination that the first response has met a second set of criteria, transforming the user interface to display the first response.

In other features, the set of criteria includes a criterion that is met when the first prompt is associated with a bias level below a bias threshold, a criterion that is met when the first prompt is associated with a toxicity level below a toxicity threshold, a criterion that is met when a confidentiality-score associated with the first prompt is below a first confidentiality-score threshold, and a criterion that is met when a first prompt does not contain one or more keywords included in a set of keywords. In other features, at least one AI system of the set of AI systems is a generative AI system. In other features, at least one AI system of the set of AI systems is a large language model. In other features, the method includes, in response to a determination that the first prompt is associated with a bias level above a bias threshold, automatically generating an alert. In other features, the method includes, in response to a determination that the first prompt is associated with a toxicity level above a toxicity threshold, automatically generating an alert. In other features, the bias level is based on content within the first prompt. In other features, the toxicity level is based on content within the first prompt. In other features, the confidentiality-score is based on an amount of private information in the first prompt. In other features, the method includes the confidentiality-score is organized into one of a set of categories including a public information category, an internal information category, a confidential information category, and a highly confidential category.

In other features, the method includes, in response to a determination that an event associated with the first prompt occurred, automatically generating an alert. In other features, the set of keywords relates to confidential information. In other features, the method includes, in response to a determination that the first prompt includes at least one keyword from the set of keywords, automatically removing the at least one keyword from the first prompt. In other features, reviewing the first prompt includes capturing metadata associated with the first prompt. In other features, the method includes in response to a determination that the first prompt includes confidential information, removing the confidential information from the first prompt. automatically using the first prompt as input to a first AI system of the set of AI systems. automatically using the first prompt as input to a second AI system of the set of AI systems. receiving a response to the first prompt from the first AI system. receiving a response to the first prompt from the second AI system, comparing the response from the first AI system and the response from the second AI system. transforming a user interface to display a revised response based on the response from the first AI system and the response from the second AI system. In other features, the method includes based on a first outcome of a third set of criteria, automatically using the first prompt as input to a first AI system of the set of AI systems. The method includes based on a second outcome of the third set of criteria, automatically using the first prompt as input to a second AI system of the set of AI systems.

In other features, third set of criteria includes a criterion that is met when the first AI system is unavailable, a criterion that is met when the second AI system is unavailable, a criterion that is met when the first AI system is optimized for a first task, a criterion that is met when the second AI system is optimized for a second task, a criterion that is met when a cost of using when the first AI system exceeds or falls below a threshold amount, a criterion that is met when a cost of using the second AI system exceeds or falls below a second threshold amount, a criterion that is met when the first AI system has a first data privacy policy, and a criterion that is met when the second AI system has a second data privacy policy. In other features, the second set of criteria includes a criterion that is met when the first response is associated with a bias level below a bias threshold, a criterion that is met when the first response is associated with a toxicity level below a toxicity threshold, a criterion that is met when a confidentiality-score associated with the first response is below a first confidentiality-score threshold, and a criterion that is met when a first response does not contain one or more keywords included in a set of keywords. In other features, the method includes receiving a set of characteristics and a characterizing number for each AI system of the set of AI systems. The method includes determining a first subset of the set of AI systems based on the set of characteristics and the characterizing number for each AI system of the set of AI systems.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a functional block diagram of an example system including a high-volume pharmacy.

FIG. 2 is a functional block diagram of an example pharmacy fulfillment device, which may be deployed within the system of FIG. 1.

FIG. 3 is a functional block diagram of an example order processing device, which may be deployed within the system of FIG. 1.

FIGS. 4A-4B are a functional block diagram of an example system for managing and controlling AI models.

FIG. 5 is a functional block diagram of an example system for managing and controlling AI models.

In the drawings, reference numbers may be reused to identify similar and/or identical elements.

### DETAILED DESCRIPTION

### Introduction

The present disclosure describes a system and method for managing and controlling access to various Artificial Intelligence (AI) systems. Recent advancements in the field of AI have greatly increased its potential to reduce expenses. While the potential these capabilities offer is significant, these advancements are not without significant risk if used without appropriate guardrails. These risks include exposing private personal information and other sensitive enterprise data, using models that were trained with implicit bias in their data sets, and susceptibility to dangerous or unethical behavior.

Managing various AI models and keeping track of their use can be challenging. For this reason, the implementation of an AI management system (or AI Gateway) is a strategic approach that serves as a central hub for managing access and interfacing with AI models. This allows users to experiment with different models, identify the most suitable ones for their specific needs, and maintain a high level of control and transparency over their use. The AI Gateway provides essential benefits such as centralized logging, monitoring, rate limiting, tracking capabilities, and recording all invocations and requests. In various embodiments, the AI Gateway includes an AI registry with a transparent view of approved use cases, involved users, and consumed models. Furthermore, it includes an integrated “circuit breaker” function, which provides the ability to instantly halt access to AI services when necessary, enhancing security and control. In various embodiments, the AI Gateway employs a streamlined model deployment methodology where AI models are deployed once and then leveraged across various projects through dynamic real-time routing. This significantly reduces the operational burden for users and ensures consistent deployment and access. In various embodiments, developers can generate their own test keys and quickly consume models for experimentation. This lowers the barrier to AI exploration and adoption, enabling efficient onboarding without extensive manual intervention.

### Automated Guideline Enforcement

In various embodiments, the AI Gateway includes automated guideline enforcement. In various embodiments, AI model guidelines are customizable and which AI model capabilities are accessible is determined by the project associated with the prompt or the user-permissions of the user submitting the prompt. Guidelines can define allowable prompt topics, maximum prompt toxicity level, maximum prompt bias level, and/or which AI models are available to a specific system, project, team and/or user.

In various embodiments, guidelines are enforced via analysis by predictive models, large language models (LLMs), and logic-based rules. Where possible, predictive models are used instead of LLMs for improved computational time. In various embodiments, one or more predictive models are trained to detect toxicity, bias, and jailbreak attempts (in other words, an attempt to bypass AI model restrictions). In various embodiments, project guidelines include preventing the sharing of personally identifiable information (“PII”) and/or personal health information (“PHI”). Detecting PII can be difficult because PII can include names, but names alone may not constitute PII. In various embodiments, a prompt is analyzed by an LLM to determine whether the prompt includes PII. In various embodiments, an LLM is used to detect the topic of a prompt and determine whether the topic is allowed by the project guidelines. For example, a project guideline may prohibit using an AI model to discuss jokes and/or poems. A reviewing LLM analyzes a submitted prompt and determines whether the prompt includes a request for a poem. If a poem request is detected, the reviewing LLM prevents the prompt from being transmitted to the AI model.

In various embodiments, guidelines are based on natural language rules, rather than logic-based rules. This allows users to manage guidelines quickly and efficiently without creating or modifying complex code logic. The natural language guidelines are interpreted by an LLM. In various embodiments, the LLM generates executable instructions (such as code) based on the natural language rules. In various embodiments, the LLM uses the natural language guidelines as a contextual input when analyzing prompts.

In various embodiments, the AI gateway includes built-in fact-checking capabilities that leverage a secondary AI model to evaluate the accuracy and reliability of responses generated by the primary model. This ensures that AI outputs undergo an additional layer of scrutiny before being returned to the consumer. By cross-referencing responses with an independent model, the system enhances trust, mitigates misinformation, and improves the overall quality of AI-generated content.

In various embodiments, AI model requests are queued instead of being invoked in real-time. This enables efficient batch processing by intelligently sorting and prioritizing requests based on project, model, and capacity availability. The AI Gateway optimizes resource allocation, ensures fair usage, and allows large-scale AI workloads to be processed seamlessly without overwhelming model limits. In various embodiments, batches of prompts are separated into groups and are sent to several models simultaneously for improved processing time.

### Model Parity

In various embodiments, AI models with similar capabilities are assigned to a parity group. For example, a parity group may include a project pool with predefined token capacities (for example, a parity group may include ai-coe-gpt4o and ai-coe-gpt4o-eastus2 which have capacities of 60,000 tokens each). In various embodiments, parity is automatically determined based on a model's known characteristics (such as token capacity or output capabilities) and each model's hierarchical evaluation and labeling of models (“HELM”) numbers.

During a model failure or overload (in other words, hitting a request or response limit), requests are automatically directed to backup models within the same parity group, ensuring uninterrupted service. In cases of systemic outages or major disruptions, model forwarding allows traffic to be rerouted to an entirely different model beyond the parity group. The AI Gateway optimizes model consumption by implementing load balancing strategies based on real-time token usage. The AI Gateway ensures efficient distribution of requests, preventing bottlenecks and optimizing cost-efficiency across multiple AI models.

### Resource Management

Managing AI consumption costs and adhering to budget constraints requires complex management systems. Certain use cases and projects that need real-time integration require dedicated AI model capacity which creates ongoing financial commitments. This requirement introduces additional complexity compared to typical “pay as you go” arrangements, as it demands careful attention to cost and resource utilization to ensure the AI infrastructure is properly sized. This issue can be addressed in several ways.

The first is token-based budget enforcement. The AI Gateway enables configuration of token and request quotas at the project and model level, preventing overuse and ensuring fair distribution of AI resources. This automated mechanism aligns model consumption with assigned budgets without manual intervention. The second is real-time rate limiting and cost governance. The platform introduces automated rate limiting and budget tracking of AI consumption, preventing overruns and unauthorized use. The system enables daily or monthly quotas to be specified at a project level and enables an overridable circuit breaker to restrict access once a quota has been met. The third is improved cost optimization. By operating at an economy of scale, the AI Gateway is utilized to its full capacity. This alignment of resource usage is continuously reviewed with project needs and projections, enabling enhanced financial management and cost savings.

### Semantic Caching

In various embodiments, the AI gateway caches AI service responses and evaluates future requests by filtering inputs, including AI request components such as system, context, query, and instructions. By orchestrating third-party ranking models for enhanced response accuracy and relevance, the cached responses remain contextually accurate and useful.

In various embodiments, the AI Gateway allows projects to use semantic caching, making it easy for teams to utilize without extensive configuration. Requestors can also opt to bypass the cache using a header when necessary. In various embodiments, when a provided system and context match exactly, the request qualifies for a semantic cache lookup process ensuring that cached responses are contextually accurate. If no match is found, the request proceeds to the AI model for further processing. In various embodiments, the query (such as the user's request and/or optional instructions) is used to enable the response ranking. Response ranking filters and ranks relevant responses, ensuring they are contextually appropriate and useful.

In various embodiments, the AI Gateway requires that both system and context match before retrieving a cached answer. This ensures that responses are standardized and consistent for each use case. This is especially beneficial for often repeated and boilerplate queries.

### High-Volume Pharmacy

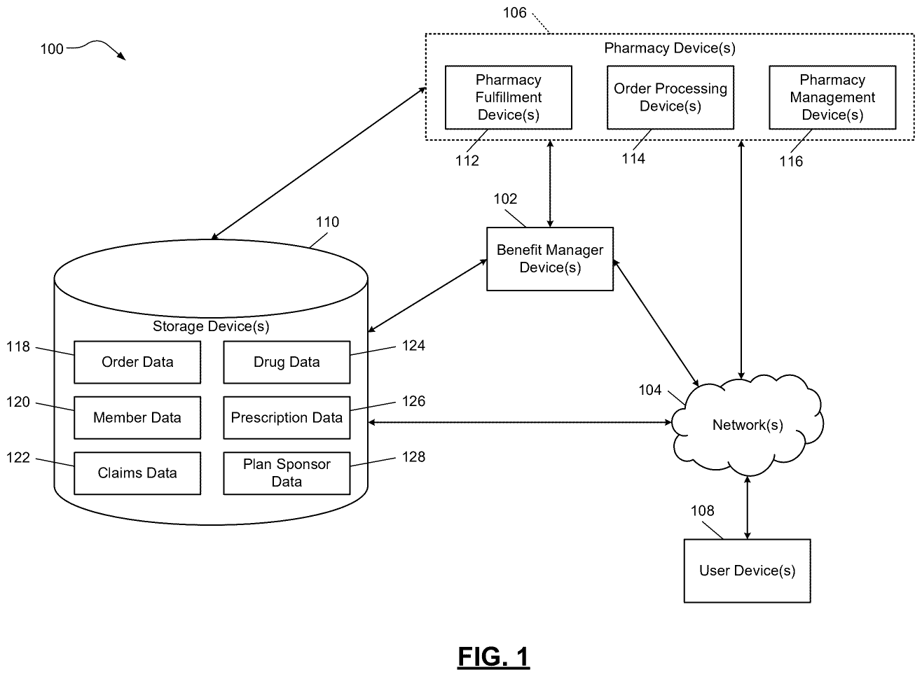

FIG. 1 is a block diagram of an example implementation of a system 100 for a high-volume pharmacy. While the system 100 is generally described as being deployed in a high-volume pharmacy or a fulfillment center (for example, a mail order pharmacy, a direct delivery pharmacy, etc.), the system 100 and/or components of the system 100 may otherwise be deployed (for example, in a lower-volume pharmacy, etc.). A high-volume pharmacy may be a pharmacy that is capable of filling at least some prescriptions mechanically. The system 100 may include a benefit manager device 102 and a pharmacy device 106 in communication with each other directly and/or over a network 104.

The system 100 may also include one or more user device(s) 108. A user, such as a pharmacist, patient, data analyst, health plan administrator, etc., may access the benefit manager device 102 or the pharmacy device 106 using the user device 108. The user device 108 may be a desktop computer, a laptop computer, a tablet, a smartphone, etc.

The benefit manager device 102 is a device operated by an entity that is at least partially responsible for creation and/or management of the pharmacy or drug benefit. While the entity operating the benefit manager device 102 is typically a pharmacy benefit manager (PBM), other entities may operate the benefit manager device 102 on behalf of themselves or other entities (such as PBMs). For example, the benefit manager device 102 may be operated by a health plan, a retail pharmacy chain, a drug wholesaler, a data analytics or other type of software-related company, etc. In some implementations, a PBM that provides the pharmacy benefit may provide one or more additional benefits including a medical or health benefit, a dental benefit, a vision benefit, a wellness benefit, a radiology benefit, a pet care benefit, an insurance benefit, a long term care benefit, a nursing home benefit, etc. The PBM may, in addition to its PBM operations, operate one or more pharmacies. The pharmacies may be retail pharmacies, mail order pharmacies, etc.

Some of the operations of the PBM that operates the benefit manager device 102 may include the following activities and processes. A member (or a person on behalf of the member) of a pharmacy benefit plan may obtain a prescription drug at a retail pharmacy location (e.g., a location of a physical store) from a pharmacist or a pharmacist technician. The member may also obtain the prescription drug through mail order drug delivery from a mail order pharmacy location, such as the system 100. In some implementations, the member may obtain the prescription drug directly or indirectly through the use of a machine, such as a kiosk, a vending unit, a mobile electronic device, or a different type of mechanical device, electrical device, electronic communication device, and/or computing device. Such a machine may be filled with the prescription drug in prescription packaging, which may include multiple prescription components, by the system 100. The pharmacy benefit plan is administered by or through the benefit manager device 102.

The member may have a copayment for the prescription drug that reflects an amount of money that the member is responsible to pay the pharmacy for the prescription drug. The money paid by the member to the pharmacy may come from, as examples, personal funds of the member, a health savings account (HSA) of the member or the member's family, a health reimbursement arrangement (HRA) of the member or the member's family, or a flexible spending account (FSA) of the member or the member's family. In some instances, an employer of the member may directly or indirectly fund or reimburse the member for the copayments.

The amount of the copayment required by the member may vary across different pharmacy benefit plans having different plan sponsors or clients and/or for different prescription drugs. The member's copayment may be a flat copayment (in one example, $10), coinsurance (in one example, 10%), and/or a deductible (for example, responsibility for the first $500 of annual prescription drug expense, etc.) for certain prescription drugs, certain types and/or classes of prescription drugs, and/or all prescription drugs. The copayment may be stored in a storage device 110 or determined by the benefit manager device 102.

In some instances, the member may not pay the copayment or may only pay a portion of the copayment for the prescription drug. For example, if a usual and customary cost for a generic version of a prescription drug is $4, and the member's flat copayment is $20 for the prescription drug, the member may only need to pay $4 to receive the prescription drug. In another example involving a worker's compensation claim, no copayment may be due by the member for the prescription drug.

In addition, copayments may also vary based on different delivery channels for the prescription drug. For example, the copayment for receiving the prescription drug from a mail order pharmacy location may be less than the copayment for receiving the prescription drug from a retail pharmacy location.

In conjunction with receiving a copayment (if any) from the member and dispensing the prescription drug to the member, the pharmacy submits a claim to the PBM for the prescription drug. After receiving the claim, the PBM (such as by using the benefit manager device 102) may perform certain adjudication operations including verifying eligibility for the member, identifying/reviewing an applicable formulary for the member to determine any appropriate copayment, coinsurance, and deductible for the prescription drug, and performing a drug utilization review (DUR) for the member. Further, the PBM may provide a response to the pharmacy (for example, the pharmacy system 100) following performance of at least some of the aforementioned operations.

As part of the adjudication, a plan sponsor (or the PBM on behalf of the plan sponsor) ultimately reimburses the pharmacy for filling the prescription drug when the prescription drug was successfully adjudicated. The aforementioned adjudication operations generally occur before the copayment is received and the prescription drug is dispensed. However in some instances, these operations may occur simultaneously, substantially simultaneously, or in a different order. In addition, more or fewer adjudication operations may be performed as at least part of the adjudication process.

The amount of reimbursement paid to the pharmacy by a plan sponsor and/or money paid by the member may be determined at least partially based on types of pharmacy networks in which the pharmacy is included. In some implementations, the amount may also be determined based on other factors. For example, if the member pays the pharmacy for the prescription drug without using the prescription or drug benefit provided by the PBM, the amount of money paid by the member may be higher than when the member uses the prescription or drug benefit. In some implementations, the amount of money received by the pharmacy for dispensing the prescription drug and for the prescription drug itself may be higher than when the member uses the prescription or drug benefit. Some or all of the foregoing operations may be performed by executing instructions stored in the benefit manager device 102 and/or an additional device.

Examples of the network 104 include a Global System for Mobile Communications (GSM) network, a code division multiple access (CDMA) network, 3rd Generation Partnership Project (3GPP), an Internet Protocol (IP) network, a Wireless Application Protocol (WAP) network, or an IEEE 802.11 standards network, as well as various combinations of the above networks. The network 104 may include an optical network. The network 104 may be a local area network or a global communication network, such as the Internet. In some implementations, the network 104 may include a network dedicated to prescription orders: a prescribing network such as the electronic prescribing network operated by Surescripts of Arlington, Virginia.

Moreover, although the system shows a single network 104, multiple networks can be used. The multiple networks may communicate in series and/or parallel with each other to link the devices 102-110.

The pharmacy device 106 may be a device associated with a retail pharmacy location (e.g., an exclusive pharmacy location, a grocery store with a retail pharmacy, or a general sales store with a retail pharmacy) or other type of pharmacy location at which a member attempts to obtain a prescription. The pharmacy may use the pharmacy device 106 to submit the claim to the PBM for adjudication.

Additionally, in some implementations, the pharmacy device 106 may enable information exchange between the pharmacy and the PBM. For example, this may allow the sharing of member information such as drug history that may allow the pharmacy to better service a member (for example, by providing more informed therapy consultation and drug interaction information). In some implementations, the benefit manager device 102 may track prescription drug fulfillment and/or other information for users that are not members, or have not identified themselves as members, at the time (or in conjunction with the time) in which they seek to have a prescription filled at a pharmacy.

The pharmacy device 106 may include a pharmacy fulfillment device 112, an order processing device 114, and a pharmacy management device 116 in communication with each other directly and/or over the network 104. The order processing device 114 may receive information regarding filling prescriptions and may direct an order component to one or more devices of the pharmacy fulfillment device 112 at a pharmacy. The pharmacy fulfillment device 112 may fulfill, dispense, aggregate, and/or pack the order components of the prescription drugs in accordance with one or more prescription orders directed by the order processing device 114.

In general, the order processing device 114 is a device located within or otherwise associated with the pharmacy to enable the pharmacy fulfillment device 112 to fulfill a prescription and dispense prescription drugs. In some implementations, the order processing device 114 may be an external order processing device separate from the pharmacy and in communication with other devices located within the pharmacy.

For example, the external order processing device may communicate with an internal pharmacy order processing device and/or other devices located within the system 100. In some implementations, the external order processing device may have limited functionality (e.g., as operated by a user requesting fulfillment of a prescription drug), while the internal pharmacy order processing device may have greater functionality (e.g., as operated by a pharmacist).

The order processing device 114 may track the prescription order as it is fulfilled by the pharmacy fulfillment device 112. The prescription order may include one or more prescription drugs to be filled by the pharmacy. The order processing device 114 may make pharmacy routing decisions and/or order consolidation decisions for the particular prescription order. The pharmacy routing decisions include what device(s) in the pharmacy are responsible for filling or otherwise handling certain portions of the prescription order. The order consolidation decisions include whether portions of one prescription order or multiple prescription orders should be shipped together for a user or a user family. The order processing device 114 may also track and/or schedule literature or paperwork associated with each prescription order or multiple prescription orders that are being shipped together. In some implementations, the order processing device 114 may operate in combination with the pharmacy management device 116.

The order processing device 114 may include circuitry, a processor, a memory to store data and instructions, and communication functionality. The order processing device 114 is dedicated to performing processes, methods, and/or instructions described in this application. Other types of electronic devices may also be used that are specifically configured to implement the processes, methods, and/or instructions described in further detail below.

In some implementations, at least some functionality of the order processing device 114 may be included in the pharmacy management device 116. The order processing device 114 may be in a client-server relationship with the pharmacy management device 116, in a peer-to-peer relationship with the pharmacy management device 116, or in a different type of relationship with the pharmacy management device 116. The order processing device 114 and/or the pharmacy management device 116 may communicate directly (for example, such as by using a local storage) and/or through the network 104 (such as by using a cloud storage configuration, software as a service, etc.) with the storage device 110.

The storage device 110 may include: non-transitory storage (for example, memory, hard disk, CD-ROM, etc.) in communication with the benefit manager device 102 and/or the pharmacy device 106 directly and/or over the network 104. The non-transitory storage may store order data 118, member data 120, claims data 122, drug data 124, prescription data 126, and/or plan sponsor data 128. Further, the system 100 may include additional devices, which may communicate with each other directly or over the network 104.

The order data 118 may be related to a prescription order. The order data may include type of the prescription drug (for example, drug name and strength) and quantity of the prescription drug. The order data 118 may also include data used for completion of the prescription, such as prescription materials. In general, prescription materials include an electronic copy of information regarding the prescription drug for inclusion with or otherwise in conjunction with the fulfilled prescription. The prescription materials may include electronic information regarding drug interaction warnings, recommended usage, possible side effects, expiration date, date of prescribing, etc. The order data 118 may be used by a high-volume fulfillment center to fulfill a pharmacy order.

In some implementations, the order data 118 includes verification information associated with fulfillment of the prescription in the pharmacy. For example, the order data 118 may include videos and/or images taken of (i) the prescription drug prior to dispensing, during dispensing, and/or after dispensing, (ii) the prescription container (for example, a prescription container and sealing lid, prescription packaging, etc.) used to contain the prescription drug prior to dispensing, during dispensing, and/or after dispensing, (iii) the packaging and/or packaging materials used to ship or otherwise deliver the prescription drug prior to dispensing, during dispensing, and/or after dispensing, and/or (iv) the fulfillment process within the pharmacy. Other types of verification information such as barcode data read from pallets, bins, trays, or carts used to transport prescriptions within the pharmacy may also be stored as order data 118.

The member data 120 includes information regarding the members associated with the PBM. The information stored as member data 120 may include personal information, personal health information, protected health information, etc. Examples of the member data 120 include name, age, date of birth, address (including city, state, and zip code), telephone number, e-mail address, medical history, prescription drug history, etc. In various implementations, the prescription drug history may include a prior authorization claim history-including the total number of prior authorization claims, approved prior authorization claims, and denied prior authorization claims. In various implementations, the prescription drug history may include previously filled claims for the member, including a date of each filled claim, a dosage of each filled claim, the drug type for each filled claim, a prescriber associated with each filled claim, and whether the drug associated with each claim is on a formulary (e.g., a list of covered medication).

In various implementations, the medical history may include whether and/or how well each member adhered to one or more specific therapies. The member data 120 may also include a plan sponsor identifier that identifies the plan sponsor associated with the member and/or a member identifier that identifies the member to the plan sponsor. The member data 120 may include a member identifier that identifies the plan sponsor associated with the user and/or a user identifier that identifies the user to the plan sponsor. In various implementations, the member data 120 may include an eligibility period for each member. For example, the eligibility period may include how long each member is eligible for coverage under the sponsored plan. The member data 120 may also include dispensation preferences such as type of label, type of cap, message preferences, language preferences, etc.

The member data 120 may be accessed by various devices in the pharmacy (for example, the high-volume fulfillment center, etc.) to obtain information used for fulfillment and shipping of prescription orders. In some implementations, an external order processing device operated by or on behalf of a member may have access to at least a portion of the member data 120 for review, verification, or other purposes.

In some implementations, the member data 120 may include information for persons who are users of the pharmacy but are not members in the pharmacy benefit plan being provided by the PBM. For example, these users may obtain drugs directly from the pharmacy, through a private label service offered by the pharmacy, the high-volume fulfillment center, or otherwise. In general, the terms “member” and “user” may be used interchangeably.

The claims data 122 includes information regarding pharmacy claims adjudicated by the PBM under a drug benefit program provided by the PBM for one or more plan sponsors. In general, the claims data 122 includes an identification of the client that sponsors the drug benefit program under which the claim is made, and/or the member that purchased the prescription drug giving rise to the claim, the prescription drug that was filled by the pharmacy (e.g., the national drug code number, etc.), the dispensing date, generic indicator, generic product identifier (GPI) number, medication class, the cost of the prescription drug provided under the drug benefit program, the copayment/coinsurance amount, rebate information, and/or member eligibility, etc. Additional information may be included.

In some implementations, other types of claims beyond prescription drug claims may be stored in the claims data 122. For example, medical claims, dental claims, wellness claims, or other types of health-care-related claims for members may be stored as a portion of the claims data 122.

In some implementations, the claims data 122 includes claims that identify the members with whom the claims are associated. Additionally or alternatively, the claims data 122 may include claims that have been de-identified (that is, associated with a unique identifier but not with a particular, identifiable member). In various implementations, the claims data 122 may include a percentage of prior authorization cases for each prescriber that have been denied, and a percentage of prior authorization cases for each prescriber that have been approved.

The drug data 124 may include drug name (e.g., technical name and/or common name), other names by which the drug is known, active ingredients, an image of the drug (such as in pill form), etc. The drug data 124 may include information associated with a single medication or multiple medications. For example, the drug data 124 may include a numerical identifier for each drug, such as the U.S. Food and Drug Administration's (FDA) National Drug Code (NDC) for each drug.

The prescription data 126 may include information regarding prescriptions that may be issued by prescribers on behalf of users, who may be members of the pharmacy benefit plan—for example, to be filled by a pharmacy. Examples of the prescription data 126 include user names, medication or treatment (such as lab tests), dosing information, etc. The prescriptions may include electronic prescriptions or paper prescriptions that have been scanned. In some implementations, the dosing information reflects a frequency of use (e.g., once a day, twice a day, before each meal, etc.) and a duration of use (e.g., a few days, a week, a few weeks, a month, etc.).

In some implementations, the order data 118 may be linked to associated member data 120, claims data 122, drug data 124, and/or prescription data 126.

The plan sponsor data 128 includes information regarding the plan sponsors of the PBM. Examples of the plan sponsor data 128 include company name, company address, contact name, contact telephone number, contact e-mail address, etc.

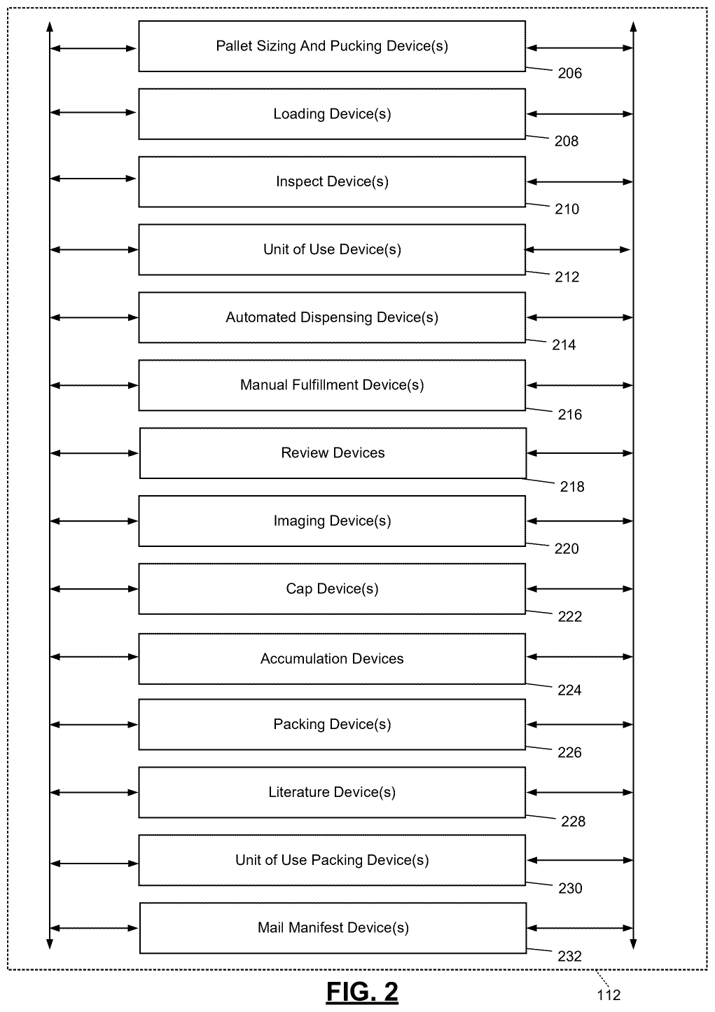

FIG. 2 illustrates the pharmacy fulfillment device 112 according to an example implementation. The pharmacy fulfillment device 112 may be used to process and fulfill prescriptions and prescription orders. After fulfillment, the fulfilled prescriptions are packed for shipping.

The pharmacy fulfillment device 112 may include devices in communication with the benefit manager device 102, the order processing device 114, and/or the storage device 110, directly or over the network 104. Specifically, the pharmacy fulfillment device 112 may include pallet sizing and pucking device(s) 206, loading device(s) 208, inspect device(s) 210, unit of use device(s) 212, automated dispensing device(s) 214, manual fulfillment device(s) 216, review devices 218, imaging device(s) 220, cap device(s) 222, accumulation devices 224, packing device(s) 226, literature device(s) 228, unit of use packing device(s) 230, and mail manifest device(s) 232. Further, the pharmacy fulfillment device 112 may include additional devices, which may communicate with each other directly or over the network 104.

In some implementations, operations performed by one of these devices 206-232 may be performed sequentially, or in parallel with the operations of another device as may be coordinated by the order processing device 114. In some implementations, the order processing device 114 tracks a prescription with the pharmacy based on operations performed by one or more of the devices 206-232.

In some implementations, the pharmacy fulfillment device 112 may transport prescription drug containers, for example, among the devices 206-232 in the high-volume fulfillment center, by use of pallets. The pallet sizing and pucking device 206 may configure pucks in a pallet. A pallet may be a transport structure for a number of prescription containers, and may include a number of cavities. A puck may be placed in one or more than one of the cavities in a pallet by the pallet sizing and pucking device 206. The puck may include a receptacle sized and shaped to receive a prescription container. Such containers may be supported by the pucks during carriage in the pallet. Different pucks may have differently sized and shaped receptacles to accommodate containers of differing sizes, as may be appropriate for different prescriptions.

The arrangement of pucks in a pallet may be determined by the order processing device 114 based on prescriptions that the order processing device 114 decides to launch. The arrangement logic may be implemented directly in the pallet sizing and pucking device 206. Once a prescription is set to be launched, a puck suitable for the appropriate size of container for that prescription may be positioned in a pallet by a robotic arm or pickers. The pallet sizing and pucking device 206 may launch a pallet once pucks have been configured in the pallet.

The loading device 208 may load prescription containers into the pucks on a pallet by a robotic arm, a pick and place mechanism (also referred to as pickers), etc. In various implementations, the loading device 208 has robotic arms or pickers to grasp a prescription container and move it to and from a pallet or a puck. The loading device 208 may also print a label that is appropriate for a container that is to be loaded onto the pallet, and apply the label to the container. The pallet may be located on a conveyor assembly during these operations (e.g., at the high-volume fulfillment center, etc.).

The inspect device 210 may verify that containers in a pallet are correctly labeled and in the correct spot on the pallet. The inspect device 210 may scan the label on one or more containers on the pallet. Labels of containers may be scanned or imaged in full or in part by the inspect device 210. Such imaging may occur after the container has been lifted out of its puck by a robotic arm, picker, etc., or may be otherwise scanned or imaged while retained in the puck. In some implementations, images and/or video captured by the inspect device 210 may be stored in the storage device 110 as order data 118.

The unit of use device 212 may temporarily store, monitor, label, and/or dispense unit of use products. In general, unit of use products are prescription drug products that may be delivered to a user or member without being repackaged at the pharmacy. These products may include pills in a container, pills in a blister pack, inhalers, etc. Prescription drug products dispensed by the unit of use device 212 may be packaged individually or collectively for shipping, or may be shipped in combination with other prescription drugs dispensed by other devices in the high-volume fulfillment center.

At least some of the operations of the devices 206-232 may be directed by the order processing device 114. For example, the manual fulfillment device 216, the review device 218, the automated dispensing device 214, and/or the packing device 226, etc. may receive instructions provided by the order processing device 114.

The automated dispensing device 214 may include one or more devices that dispense prescription drugs or pharmaceuticals into prescription containers in accordance with one or multiple prescription orders. In general, the automated dispensing device 214 may include mechanical and electronic components with, in some implementations, software and/or logic to facilitate pharmaceutical dispensing that would otherwise be performed in a manual fashion by a pharmacist and/or pharmacist technician. For example, the automated dispensing device 214 may include high-volume fillers that fill a number of prescription drug types at a rapid rate and blister pack machines that dispense and pack drugs into a blister pack. Prescription drugs dispensed by the automated dispensing devices 214 may be packaged individually or collectively for shipping, or may be shipped in combination with other prescription drugs dispensed by other devices in the high-volume fulfillment center.

The manual fulfillment device 216 controls how prescriptions are manually fulfilled. For example, the manual fulfillment device 216 may receive or obtain a container and enable fulfillment of the container by a pharmacist or pharmacy technician. In some implementations, the manual fulfillment device 216 provides the filled container to another device in the pharmacy fulfillment devices 112 to be joined with other containers in a prescription order for a user or member.

In general, manual fulfillment may include operations at least partially performed by a pharmacist or a pharmacy technician. For example, a person may retrieve a supply of the prescribed drug, may make an observation, may count out a prescribed quantity of drugs and place them into a prescription container, etc. Some portions of the manual fulfillment process may be automated by use of a machine. For example, counting of capsules, tablets, or pills may be at least partially automated (such as through use of a pill counter). Prescription drugs dispensed by the manual fulfillment device 216 may be packaged individually or collectively for shipping, or may be shipped in combination with other prescription drugs dispensed by other devices in the high-volume fulfillment center.

The review device 218 may process prescription containers to be reviewed by a pharmacist for proper pill count, exception handling, prescription verification, etc. Fulfilled prescriptions may be manually reviewed and/or verified by a pharmacist, as may be required by state or local law. A pharmacist or other licensed pharmacy person who may dispense certain drugs in compliance with local and/or other laws may operate the review device 218 and visually inspect a prescription container that has been filled with a prescription drug. The pharmacist may review, verify, and/or evaluate drug quantity, drug strength, and/or drug interaction concerns, or otherwise perform pharmacist services. The pharmacist may also handle containers which have been flagged as an exception, such as containers with unreadable labels, containers for which the associated prescription order has been canceled, containers with defects, etc. In an example, the manual review can be performed at a manual review station.

The imaging device 220 may image containers once they have been filled with pharmaceuticals. The imaging device 220 may measure a fill height of the pharmaceuticals in the container based on the obtained image to determine if the container is filled to the correct height given the type of pharmaceutical and the number of pills in the prescription. Images of the pills in the container may also be obtained to detect the size of the pills themselves and markings thereon. The images may be transmitted to the order processing device 114 and/or stored in the storage device 110 as part of the order data 118.

The cap device 222 may be used to cap or otherwise seal a prescription container. In some implementations, the cap device 222 may secure a prescription container with a type of cap in accordance with a user preference (e.g., a preference regarding child resistance, etc.), a plan sponsor preference, a prescriber preference, etc. The cap device 222 may also etch a message into the cap, although this process may be performed by a subsequent device in the high-volume fulfillment center.

The accumulation device 224 accumulates various containers of prescription drugs in a prescription order. The accumulation device 224 may accumulate prescription containers from various devices or areas of the pharmacy. For example, the accumulation device 224 may accumulate prescription containers from the unit of use device 212, the automated dispensing device 214, the manual fulfillment device 216, and the review device 218. The accumulation device 224 may be used to group the prescription containers prior to shipment to the member.

The literature device 228 prints, or otherwise generates, literature to include with each prescription drug order. The literature may be printed on multiple sheets of substrates, such as paper, coated paper, printable polymers, or combinations of the above substrates. The literature printed by the literature device 228 may include information required to accompany the prescription drugs included in a prescription order, other information related to prescription drugs in the order, financial information associated with the order (for example, an invoice or an account statement), etc.

In some implementations, the literature device 228 folds or otherwise prepares the literature for inclusion with a prescription drug order (e.g., in a shipping container). In other implementations, the literature device 228 prints the literature and is separate from another device that prepares the printed literature for inclusion with a prescription order.

The packing device 226 packages the prescription order in preparation for shipping the order. The packing device 226 may box, bag, or otherwise package the fulfilled prescription order for delivery. The packing device 226 may further place inserts (e.g., literature or other papers, etc.) into the packaging received from the literature device 228. For example, bulk prescription orders may be shipped in a box, while other prescription orders may be shipped in a bag, which may be a wrap seal bag.

The packing device 226 may label the box or bag with an address and a recipient's name. The label may be printed and affixed to the bag or box, be printed directly onto the bag or box, or otherwise associated with the bag or box. The packing device 226 may sort the box or bag for mailing in an efficient manner (e.g., sort by delivery address, etc.). The packing device 226 may include ice or temperature sensitive elements for prescriptions that are to be kept within a temperature range during shipping (for example, this may be necessary in order to retain efficacy). The ultimate package may then be shipped through postal mail, through a mail order delivery service that ships via ground and/or air (e.g., UPS, FEDEX, or DHL, etc.), through a delivery service, through a locker box at a shipping site (e.g., AMAZON locker or a PO Box, etc.), or otherwise.

The unit of use packing device 230 packages a unit of use prescription order in preparation for shipping the order. The unit of use packing device 230 may include manual scanning of containers to be bagged for shipping to verify each container in the order. In an example implementation, the manual scanning may be performed at a manual scanning station. The pharmacy fulfillment device 112 may also include a mail manifest device 232 to print mailing labels used by the packing device 226 and may print shipping manifests and packing lists.

While the pharmacy fulfillment device 112 in FIG. 2 is shown to include single devices 206-232, multiple devices may be used. When multiple devices are present, the multiple devices may be of the same device type or models, or may be a different device type or model. The types of devices 206-232 shown in FIG. 2 are example devices. In other configurations of the system 100, lesser, additional, or different types of devices may be included.

Moreover, multiple devices may share processing and/or memory resources. The devices 206-232 may be located in the same area or in different locations. For example, the devices 206-232 may be located in a building or set of adjoining buildings. The devices 206-232 may be interconnected (such as by conveyors), networked, and/or otherwise in contact with one another or integrated with one another (e.g., at the high-volume fulfillment center, etc.). In addition, the functionality of a device may be split among a number of discrete devices and/or combined with other devices.

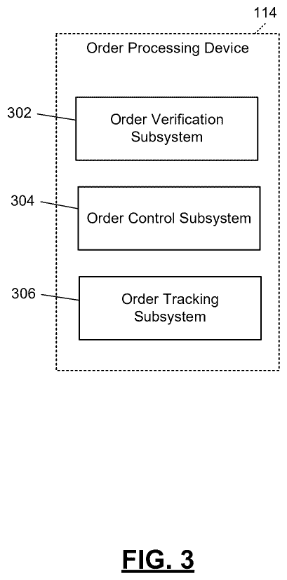

FIG. 3 illustrates the order processing device 114 according to an example implementation. The order processing device 114 may be used by one or more operators to generate prescription orders, make routing decisions, make prescription order consolidation decisions, track literature with the system 100, and/or view order status and other order related information. For example, the prescription order may be comprised of order components.

The order processing device 114 may receive instructions to fulfill an order without operator intervention. An order component may include a prescription drug fulfilled by use of a container through the system 100. The order processing device 114 may include an order verification subsystem 302, an order control subsystem 304, and/or an order tracking subsystem 306. Other subsystems may also be included in the order processing device 114.

The order verification subsystem 302 may communicate with the benefit manager device 102 to verify the eligibility of the member and review the formulary to determine appropriate copayment, coinsurance, and deductible for the prescription drug and/or perform a DUR (drug utilization review). Other communications between the order verification subsystem 302 and the benefit manager device 102 may be performed for a variety of purposes.

The order control subsystem 304 controls various movements of the containers and/or pallets along with various filling functions during their progression through the system 100. In some implementations, the order control subsystem 304 may identify the prescribed drug in one or more than one prescription orders as capable of being fulfilled by the automated dispensing device 214. The order control subsystem 304 may determine which prescriptions are to be launched and may determine that a pallet of automated-fill containers is to be launched.

The order control subsystem 304 may determine that an automated-fill prescription of a specific pharmaceutical is to be launched and may examine a queue of orders awaiting fulfillment for other prescription orders, which will be filled with the same pharmaceutical. The order control subsystem 304 may then launch orders with similar automated-fill pharmaceutical needs together in a pallet to the automated dispensing device 214. As the devices 206-232 may be interconnected by a system of conveyors or other container movement systems, the order control subsystem 304 may control various conveyors: for example, to deliver the pallet from the loading device 208 to the manual fulfillment device 216 from the literature device 228, paperwork as needed to fill the prescription.

The order tracking subsystem 306 may track a prescription order during its progress toward fulfillment. The order tracking subsystem 306 may track, record, and/or update order history, order status, etc. The order tracking subsystem 306 may store data locally (for example, in a memory) or as a portion of the order data 118 stored in the storage device 110.

### Block Diagrams

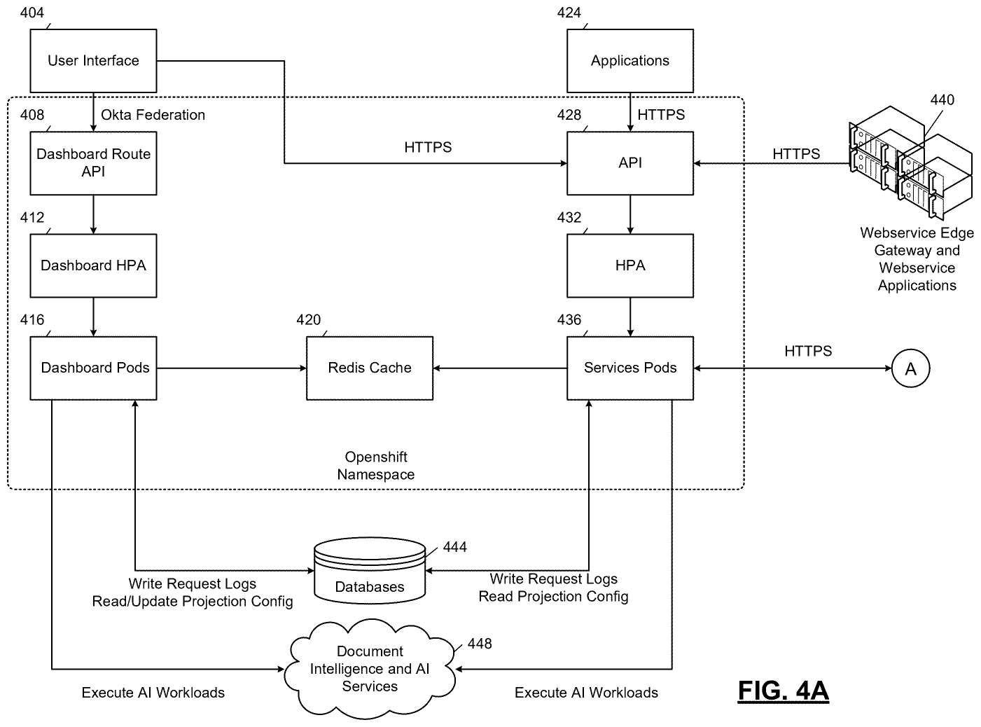

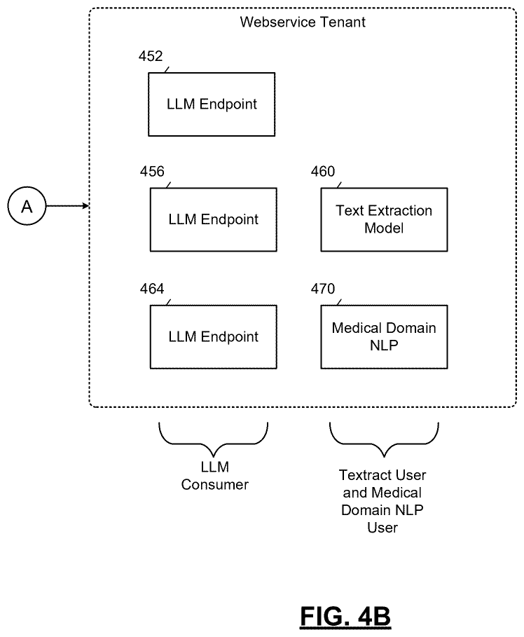

FIGS. 4A-4B are a functional block diagram of an example system for managing and controlling access to AI models. User interface 404 receives user input and communicates with dashboard route API 408 (via identity token authorization with systems such as Okta Federation) and API 428. Dashboard route API 408 and API 428 allow a user to use a single interface such as user interface 404 for various AI system functionalities. Dashboard route API 408 and API 428 communicate with HPA 412 and HPA 432 respectively. HPA 412 and HPA 432 are horizontal pod autoscalers.

Dashboard pods 416 and services pods 436 are passive data structures used to store and manage information for databases 444 and document intelligence and AI services 448. Dashboard pods 416 and services pods 436 log requests and automatically route service requests to the applicable service and manage executing AI workloads via private link. Services pods 436 communicates with LLM endpoint 452, LLM endpoint 456, LLM endpoint 464, text extraction model 460, and medical domain NLP 470 to execute AI workloads. LLM endpoint 452, 456, and 464 are various LLMs (large language models). Text extraction model 460 is a machine learning model capable of text extraction (such as optical character recognition). Medical domain NLP 470 is a natural language processing system designed specifically for medical terms.

Dashboard pods 416 work with databases 444 and document intelligence and AI services 448 for functionality. Databases 444 stores logs and configurations. In some implementations, databases 444 contains client information for use with AI systems and/or generative AI. In some implementations, data from databases 444 is compared against prompts to confirm that client information is not used in generative AI and/or AI systems.

Redis cache 420 is used to broker information between dashboard pods 416 and services pods 436. For example, redis cache 420 is used to track and maintain token consumption and project configuration data. API 428 interprets commands from user interface 404, applications 424, and webservice edge gateway and webservice applications 440. Applications 424 invoke HTTPS requests via a route. The dashboard, managed by AI CoE administrators, offers a WYSIWYG Studio for testing and onboarding. Users can also conduct local tests against AI Gateway services.

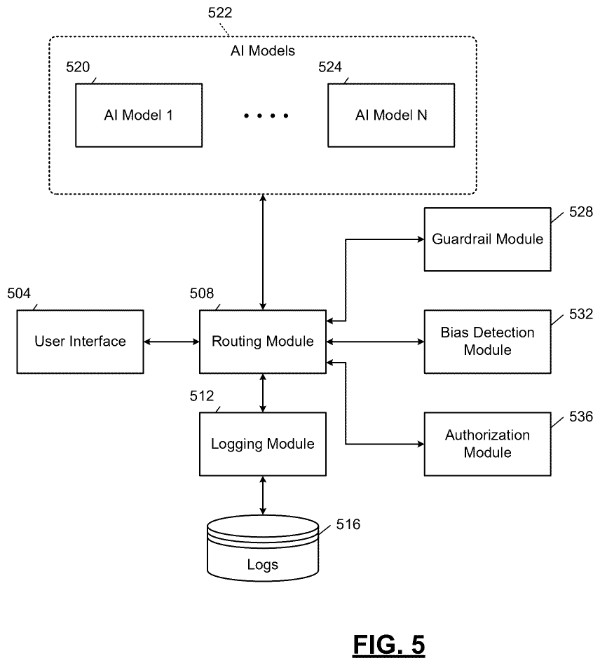

FIG. 5 is a functional block diagram of an example system for managing and controlling access to AI models 522. User interface 504 is transformed to display information and options regarding accessing AI models 522 (such as AI model 1 (520) and AI model N (524)), alerts, error prompts, steps for use or other requirements, confidentiality-scores, bias reports and/or toxicity reports. In some implementations, user interface 504 accepts user input. Input from user interface 504 (such as an AI prompt) is sent to routing module 508.

Routing module 508 manages where and when to send information such as AI prompts, AI responses, logging, reports, and/or alerts. For example, AI prompts submitted from user interface 504 and the associated user metadata (e.g., user login information, time stamps, location, submitted prompts, etc.) are sent to logging module 512 and saved in logs 516. In some implementations, logs 516 stores configuration data. Responses from AI models 522 are also logged by logging module 512 in logs 516.

Routing module 508 also communicates with authorization module 536 to confirm that the user accessing user interface 504 has access to information included in a particular prompt, response from an AI model, or to a particular AI system. In some implementations, the authorization determination of authorization module 536 is displayed in user interface 504 informing the user of the available configuration options (based on the associated authorization level or AI model to be used). Reviewed and authorized prompts are sent to AI models 522 (such as AL model 1 (520) and AI model N (524)). In some implementations, AI models 522 includes 1, 3, 5, 10, or 100 models. In some implementations, routing module 508 determines which AI model to send a prompt to. In some implementations, a prompt is sent to a particular AI model based on availability, optimization for a particular task, costs (determined based on comparisons and/or costs falling below or exceeding an adjustable cost threshold), and/or data privacy standards and policies associated with an AI model. In some implementations, a prompt is sent to a plurality of AI models. In some implementations, responses of different AI models are compared and analyzed for accuracy. In some implementations, responses of different AI models are combined.

Responses from AI models 522 can be further analyzed in bias detection module 532 and guardrail module 528. AI models 522, the content of AI responses, and/or the content AI prompts are analyzed in bias detection module 532 for bias and/or toxicity. The bias and/or toxicity of AI models 522 is determined based on training data or other known parameters of AI models 522. Bias and toxicity can be determined based on a set of criteria. Based on the outcome of the set of criteria, guardrail module 528 and bias detection module 532 may automatically edit or reject a prompt and/or response. A response (e.g., output file or token) from the modules 528 (e.g., unedited prompt or response; edited prompt or response; or rejection of prompt or response) can be fed back to the AI models 522 to train the models 522 on acceptable responses. This may lessen the frequency of editing, rejecting or both of a response from the AI models. The AI models 522 may receive this feedback from more than one of the bias detection module 532, guardrail module 528, the authorization module 536, or combinations thereof. The module feedback can be incorporated into the retraining of the AI models to improve the results.

Guardrail module 528 can perform a number of functionalities, including a review for confidential information in prompts and/or responses. In some implementations, prompts and responses receive a confidentiality-score based on the amount of public, internal, confidential, or highly confidential information in the prompts/responses. In some implementations, the prompts/responses are organized into different confidentiality categories based on the whether the confidentiality of the information reaches various confidentiality thresholds. In some implementations, guardrail module 528 inspects response/prompts for keywords related to confidential information. In some implementations, alerts are automatically displayed via user interface 504 if bias, toxicity, confidentiality, and/or keyword requirements are not met. In some implementations, guardrail module 528 automatically removes confidential information, confidential keywords, and/or bias from AI prompts. In some implementations, guardrail module 528 will generate an alert if an event associated with a response and/or prompt as occurred. In some implementations, guardrail module 528 can generate an alert or signal to immediately interrupt access to an AI model if criteria are met.

The AI models 522 can include AI models described in co-pending U.S. patent Ser. No. 18/946,471, filed 13 Nov. 2024, titled SYSTEMS AND METHODS FOR USING GENERATIVE ARTIFICIAL INTELLIGENCE (AI) TO GENERATE COMPUTER CODE AND STRUCTURED DATA, which is hereby incorporated by reference. For example the block diagram 1400 of U.S. patent Ser. No. 18/946,471 shows an example service of enhanced process/system training input One example of a training input can be the outputs from the guardrail module 528, the bias detection module 532, the authorization module 536, The training system and methods of U.S. patent Ser. No. 18/946,471 can be used with various AI models 522 and in some embodiments is not limited to a teleservice example. The outputs from the modules 528, 532, 536 can be feedback after the initial training of the AI models.

The AI models can include any one or combination of classifiers or neural networks, such as an artificial neural network, a convolutional neural network, an adversarial network, a generative adversarial network, a deep feed forward network, a radial basis network, a recurrent neural network, a long/short term memory network, a gated recurrent unit, an auto encoder, a variational autoencoder, a denoising autoencoder, a sparse autoencoder, a Markov chain, a Hopfield network, a Boltzmann machine, a restricted Boltzmann machine, a deep belief network, a deep convolutional network, a deconvolutional network, a deep convolutional inverse graphics network, a liquid state machine, an extreme learning machine, an echo state network, a deep residual network, a Kohonen network, a support vector machine, a neural Turing machine, and the like. These classifiers or neural networks can receive outputs from the modules 528, 532, 536 to retrain the AI models 522

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

As noted below, the term “set” generally means a grouping of one or more elements. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set—that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” can be replaced with the term “controller” or the term “circuit.” In this application, the term “controller” can be replaced with the term “module.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); processor hardware (shared, dedicated, or group) that executes code; memory hardware (shared, dedicated, or group) that is coupled with the processor hardware and stores code executed by the processor hardware; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module. The term memory hardware is a subset of the term computer-readable medium.

The apparatuses and methods described in this application may be partially or fully implemented by a special-purpose computer created by configuring a general-purpose computer to execute one or more particular functions embodied in computer programs. Such apparatuses and methods may be described as computerized or computer-implemented apparatuses and methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special-purpose computer, device drivers that interact with particular devices of the special-purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A method for managing a set of artificial intelligence (AI) systems, the method comprising:
receiving an identity token associated with a first user;
determining whether the identity token associated with the first user is authorized;
in response to a determination that the identity token associated with the first user is not authorized, transforming a user interface to display a first error prompt;
in response to a determination that the identity token associated with the first user is authorized, reviewing a first prompt by determining whether the first prompt has met a set of criteria;
in response to a determination that the first prompt has met the set of criteria, using the first prompt as input to the set of AI systems;
receiving a first response associated with the first prompt from the set of AI systems; and
in response to a determination that the first response has met a second set of criteria, transforming the user interface to display the first response.

2. The method of claim 1 wherein the set of criteria includes:
a criterion that is met when the first prompt is associated with a bias level below a bias threshold,
a criterion that is met when the first prompt is associated with a toxicity level below a toxicity threshold,
a criterion that is met when a confidentiality-score associated with the first prompt is below a first confidentiality-score threshold, and
a criterion that is met when a first prompt does not contain one or more keywords included in a set of keywords.

3. The method of claim 1 wherein at least one AI system of the set of AI systems is a generative AI system.

4. The method of claim 1 wherein at least one AI system of the set of AI systems is a large language model.

5. The method of claim 2 further comprising, in response to a determination that the first prompt is associated with a bias level above a bias threshold, automatically generating an alert.

6. The method of claim 2 further comprising, in response to a determination that the first prompt is associated with a toxicity level above a toxicity threshold, automatically generating an alert.

7. The method of claim 2 wherein the bias level is based on content within the first prompt.

8. The method of claim 2 wherein the toxicity level is based on content within the first prompt.

9. The method of claim 2 wherein the confidentiality-score is based on an amount of private information in the first prompt.

10. The method of claim 2 further comprising wherein the confidentiality-score is organized into one of a set of categories including:
a public information category,
an internal information category,
a confidential information category, and
a highly confidential category.

11. The method of claim 2 further comprising, in response to a determination that an event associated with the first prompt occurred, automatically generating an alert.

12. The method of claim 2 wherein the set of keywords relates to confidential information.

13. The method of claim 2 further comprising, in response to a determination that the first prompt includes at least one keyword from the set of keywords, automatically removing the at least one keyword from the first prompt.

14. The method of claim 1 wherein reviewing the first prompt includes capturing metadata associated with the first prompt.

15. The method of claim 1 further comprising:
in response to a determination that the first prompt includes confidential information, removing the confidential information from the first prompt;
automatically using the first prompt as input to a first AI system of the set of AI systems;
automatically using the first prompt as input to a second AI system of the set of AI systems;
receiving a response to the first prompt from the first AI system;
receiving a response to the first prompt from the second AI system;
comparing the response from the first AI system and the response from the second AI system; and
transforming a user interface to display a revised response based on the response from the first AI system and the response from the second AI system.

16. The method of claim 1 further comprising:
based on a first outcome of a third set of criteria, automatically using the first prompt as input to a first AI system of the set of AI systems; and
based on a second outcome of the third set of criteria, automatically using the first prompt as input to a second AI system of the set of AI systems.

17. The method of claim 16 wherein third set of criteria includes:
a criterion that is met when the first AI system is unavailable,
a criterion that is met when the second AI system is unavailable,
a criterion that is met when the first AI system is optimized for a first task,
a criterion that is met when the second AI system is optimized for a second task,
a criterion that is met when a cost of using when the first AI system exceeds or falls below a threshold amount,
a criterion that is met when a cost of using the second AI system exceeds or falls below a second threshold amount,
a criterion that is met when the first AI system has a first data privacy policy, and
a criterion that is met when the second AI system has a second data privacy policy.

18. The method of claim 1 wherein the second set of criteria includes:
a criterion that is met when the first response is associated with a bias level below a bias threshold,
a criterion that is met when the first response is associated with a toxicity level below a toxicity threshold,
a criterion that is met when a confidentiality-score associated with the first response is below a first confidentiality-score threshold, and
a criterion that is met when a first response does not contain one or more keywords included in a set of keywords.

19. The method of claim 1 further comprising:
receiving a set of characteristics and a characterizing number for each AI system of the set of AI systems; and
determining a first subset of the set of AI systems based on the set of characteristics and the characterizing number for each AI system of the set of AI systems.
